(19) United States
(12) Patent Application Publication
(10) Pub. No.: US 2009/0076942 A1
(43) Pub. Date: Mar. 19, 2009

(54) FINANCIAL INSTRUMENTS, AND SYSTEMS AND METHODS FOR USE WITH FINANCIAL INSTRUMENTS

(75) Inventor: JEFFREY HOLTUM POULSEN, Collingwood (CA)

Correspondence Address: ALSTON & BIRD LLP, BANK OF AMERICA PLAZA, 101 SOUTH TRYON STREET, SUITE 4000, CHARLOTTE, NC, 28280-4000, US

(73) Assignee: BMO Nesbitt Burns Corporation Limited

(21) Appl. No.: 12/141,486

(22) Filed: Jun. 18, 2008

(30) Foreign Application Priority Data
Jun. 18, 2007 (CA) 2,591,903

(51) Int. Cl. G06Q 40/00

(52) U.S. Cl. 705/37; 705/35

(57) ABSTRACT

Variable rate of return debt instrument has principal amount (“principal”), maturity date, term, return on principal, and obligations for principal repayment by maturity date, and payment of return at maturity date. Return is indeterminable during term. A debt instrument may be ordered individually or together with another complementary debt instrument that similarly has an indeterminable return during the term, which includes a possibility of no return. Systems and methods for ordering the debt instruments are provided. When two complementary debt instruments are combined, the aggregate return of the two instruments is certain to be greater than a minimum amount greater than zero. The debt instruments can provide investor with commercial and tax advantages. Complementary combinations of debt instruments may be ordered individually. However, for convenience of purchase, investors may order a predetermined combination of two complementary debt instruments. Debt instrument may be promissory notes, guaranteed investment certificates or other forms of indebtedness.

The present application claims priority from, and the benefit of the filing date of, Canadian Patent Application No. 2,591,903, filed on 18 Jun. 2007, the entire content of which is hereby incorporated by reference herein.

### FIELD OF THE INVENTION

The invention relates to variable rate of return debt instruments, and to systems and methods for offering, ordering and order settlement of such debt instruments, which may be sold as investment securities. The invention also relates to systems and methods for ordering and settling orders for securities.

### BACKGROUND OF THE INVENTION

A variable rate of return debt instrument, such as a variable rate of return note (VRN), is purchased by an investor from an issuer for a given amount, typically referred to as the principal amount of the VRN. The VRN matures on a given date, commonly referred to as the maturity date. The time from purchase to maturity is commonly referred to as the term of the VRN. Any increase in value of the VRN above the principal is referred to as the return on the principal of the VRN. The VRN obligates an issuer to pay the return and the principal amount to the investor. The rate of return is variable as the return varies with the performance of a reference portfolio.

Similarly, a fixed return debt instrument (FRDI) is also typically purchased by an investor from an issuer for a fixed principal amount, with the FRDI having a set term to the instrument's maturity date. However, in contrast to a VRN, the rate of return on a FRDI is fixed and ascertainable at the date of issuance of the FRDI.

VRNs are sometimes referred to as variable rate interest notes (VRINs). Depending on the identity of the issuer, a VRN can take different forms. As an example, where the issuer is a deposit taking institution, such as a bank, the VRN is a variable rate deposit note (VRDN). In many jurisdictions VRDNs are more easily issued than other VRNs due to the application of differing securities regulations that exempt such instruments from certain disclosure and registration requirements. If the return is paid as interest on a deposit, the VRN may be referred to as a variable rate interest deposit note (VRIDN).

A typical VRN has two distinct elements: a principal repayment obligation and a return determined by the performance of a reference portfolio, one or more indexes and/or some other reference point.

The reference point for determining the return of a VRN generally takes one of two forms: a portfolio of securities (or securities index) or a commodity portfolio or index. However, other criteria or reference points can be used to determine the return on a VRN.

Equity-linked deposit notes are VRNs referenced to the performance of one or more equity instruments. Commonly used types of equity linked VRNs include mutual fund reference deposit notes (return referenced to a mutual fund); hedge fund reference deposit notes (return referenced to a hedge fund or fund of hedge funds); and index reference deposit notes (return referenced to an equity index, such as the S&P or TSX Composite Index, or the NASDAQ 100).

Commodity linked deposit notes are VRNs referenced to the performance of a portfolio of commodities, including for example a portfolio of a single commodity. The most common types are managed futures reference notes (return is referenced to a pool of futures contracts managed by a commodity trading adviser).

VRNs provide benefits to all participants including VRN holders, issuers, and parties involved in structuring the VRN (structurers) or in managing the reference portfolio for an issuer (managers).

For investors VRNs provide potentially higher returns than a traditional bank deposit or FRDI. Because the return of the VRN is linked to a riskier investment such as an equity or commodity, investors have an opportunity to achieve higher returns than would be available through a conventional FRDI. Investors are also provided with a principal repayment guarantee, preferably from highly rated issuers that are unlikely to default on returning the invested capital. Investors also obtain tax deferral because the determination and payment of the variable return (income or appreciation) on the VRNs are usually delayed until maturity, thus generally deferring taxes on the return until maturity, whereas the returns of principal during the term are not as such subject to taxation.

For issuers VRNs provide access to higher yield seeking investors. Without VRNs issuers are generally limited to providing FRDIs whose return is based on the time value of money determined by current market conditions. FRDIs are not attractive to investors who desire higher returns.

FRDIs generally appeal to investors who seek certain returns with minimal risk of financial loss.

Issuers of VRNs and FRDIs collect fees for guaranteeing the full repayment of the principal amount on debt obligations. For example, where the issuer is a bank, the bank collects fees from investors for protecting the principal amount which are deducted from the overall return. Issuers can also gain access to a broader investor base where an offering of notes is not governed by the same securities legislation restrictions that would govern an offering of the underlying asset. This may be the case, for example, under current Canadian provincial securities legislation. Accordingly, it may be possible to offer notes to investors without the need to comply with certain prospectus and registration requirements.

For structurers there are fees to be collected for structuring the VRNs and FRDIs. Structurers collect fees for activities such as providing administrative services, managing the underlying fund or managed futures pool, providing unique return profiles and/or providing leverage. These fees are also deducted from the variable return on the VRNs and FRDIs.

VRNs typically defer payment of returns until maturity in order to achieve tax deferral, which is unlike a traditional fixed interest deposit. In many jurisdictions, interest income, whether paid currently or accrued, on conventional debt securities is subject to a relatively high rate of income tax. One attempted solution to this problem was to defer the payment of the variable interest income amount, which cannot be ascertained until maturity, until the maturity of the debt, thereby deferring any requirement to pay income tax on interest accruing or payable over the life of the instrument. However, with this approach the investor is deprived of a stream of income during the term of the VRN.

Unlike VRNs, FRDIs are typically subject to tax rules that require investors to recognize any accrued return on the FRDI annually on an accrual basis even if not paid until maturity. Specific tax rules generally require such annual income recognition once it can be determined that a minimum or maximum amount or return will be payable on the FRDI in any event.

### SUMMARY OF THE INVENTION

In a first aspect the invention provides a system for ordering debt instruments. The system includes an order placement system configured to accept automatically orders for debt instruments from a set of classes of debt instruments having respective maturity payments of each class of debt instrument determined such that the amount of the maturity payment is indeterminable until on or about a maturity date of the debt instruments, such that it is possible for the maturity payment for debt instruments from each class to be less than or equal to any remaining principal for a debt instrument from that class, and such that an aggregate amount of the maturity payments for any combination of debt instruments from a plurality of the classes of debt instruments is greater than the remaining principal for the combination of debt instruments by a minimum amount.

The system may further include a computer system having input means. The computer system may be for communicating orders input through the input means to the order placement system. The computer system may include a graphical display interface to display visually communications between the computer system and the order placement system.

The order placement system may include a multiple class ordering code representing respective non-zero quantities of debt instruments from a plurality of the classes of debt instruments, and the ordering system may automatically accept orders for the debt instruments utilizing the multiple class ordering code.

The system may further include a conversion module configured to convert automatically an order accepted utilizing the multiple class ordering code into respective quantities of each class of debt instruments represented.

The system may further include a conversion module for converting automatically an order accepted utilizing the multiple class ordering code into orders to the order placement system for respective quantities of each class of debt instruments represented, wherein the order placement system may be configured to accept orders for each class of debt instruments utilizing respective single class ordering codes.

The order placement system may be configured to accept automatically orders for the debt instruments utilizing a set of class ordering codes representing a series of combinations of quantities of debt instruments from one or more classes of debt instruments. The system may include a conversion module for converting orders accepted utilizing the set of class ordering codes representing a series of combinations of quantities of debt instruments from a plurality of the classes of debt instruments into orders for respective quantities of each class of debt instruments.

The conversion module may be separate from the order placement system and interact automatically with the order placement system. The conversion module may be part of the order placement system.

In a second aspect the invention provides a method of ordering debt instruments. The method includes accepting orders for debt instruments from a set of classes of debt instruments having respective maturity payments of each class of debt instrument determined such that the amount of the maturity payment is indeterminable until on or about a maturity date of the debt instruments, such that it is possible for the maturity payment for debt instruments from each class to be less than or equal to any remaining principal for a debt instrument from that class, and such that an aggregate amount of the maturity payments for any combination of debt instruments from a plurality of the classes of debt instruments is greater than or equal to the remaining principal for the combination of debt instruments.

Orders may be accepted utilizing a multiple class ordering code representing respective non-zero quantities of debt instruments from a plurality of the classes of debt instruments. Orders may be accepted utilizing a set of greater than two class ordering codes representing a series of combinations of quantities of debt instruments from a plurality of the classes of debt instruments.

Orders accepted during the step of accepting orders may be automatically accepted at an order placement system configured to accept automatically the orders.

The step of accepting orders may further include accepting orders utilizing a multiple class ordering code representing respective quantities of debt instruments from a plurality of the classes of debt instruments.

The step of accepting orders may further include accepting orders utilizing a set of class ordering codes representing a series of combinations of quantities of debt instruments from a plurality of the classes of debt instruments.

The method may include the step of inputting orders through a computer system for communication to the order placement system.

The method may include the step of visually displaying communications between the computer system and the order placement system on a display of the computer system.

The method may include the step of automatically converting a quantity of debt instruments in orders accepted by the order placement system utilizing a multiple class ordering code into respective quantities of each class of debt instruments represented.

The method may include the step of automatically converting a quantity of debt instruments in orders accepted by the order placement system utilizing a multiple class ordering code into orders to the order placement system for respective quantities of each class of debt instruments represented utilizing respective single class ordering codes.

The method may include the step of, prior to accepting orders, configuring the order placement system to accept the orders.

The ordering code may be one of a set of class ordering codes representing a series of combinations of quantities of debt instruments from the classes of debt instruments.

In a third aspect the invention provides an order placement system including a computer system configured with a set of class ordering codes representing a plurality of classes of financial instruments, wherein the computer system is configured to accept automatically communications of orders for the financial instruments utilizing the class ordering codes, wherein the set of ordering codes comprises a multiple class ordering code representing a plurality of debt instruments from a set of classes of debt instruments having respective maturity payments of each class of debt instrument determined such that the amount of the maturity payment is indeterminable until on or about a maturity date of the debt instruments, such that it is possible for the maturity payment for debt instruments from each class to be less than or equal to any remaining principal for a debt instrument from that class, and such that an aggregate amount of the maturity payments for any combination of debt instruments from a plurality of the classes of debt instruments is greater than the remaining principal for the combination of debt instruments by a minimum amount.

The debt instruments for the above aspects may be deposit notes.

In a fourth aspect the invention provides a debt instrument including a principal amount (“principal”), a maturity date, a term ending on the maturity date, a recurring period, an obligation for repayment of the principal by on or about the maturity date, and an obligation for payment of a maturity payment at the maturity date. The amount of the maturity payment is indeterminable until on or about the maturity date, and is determined based on a value of a financial benchmark on or about the maturity date.

The financial benchmark may be a banker's acceptance rate. The financial benchmark may be a 3 month banker's acceptance rate.

The maturity payment may be determined based on a given multiplier of the value of the financial benchmark.

The debt instrument may further include a recurring period with a portion of the principal to be repaid during each recurring period of the term. The portion of principal to be repaid prior to maturity may be fixed on or before issuance of the instrument. The portion of principal to be repaid in each recurring period prior to the maturity date may be roughly equivalent to interest that would be paid on the principal during such period at prevailing interest rates offered to retail investors on investment grade debt instruments. The portion of principal to be repaid during any recurring period of the term may be variable. Alternatively, all of the principal may be repaid on or about the maturity date.

In a fifth aspect the invention provides a set of classes of debt instruments including a plurality of classes of debt instruments in accordance with the fourth aspect. The respective amounts of the maturity payments of each class of debt instrument are determined such that the amount of the maturity payment is indeterminable until on or about a maturity date of the debt instruments, such that it is possible for the maturity payment for debt instruments from each class of debt instrument to be less than or equal to any remaining principal for a debt instrument from that class, and such that the aggregate amount of the maturity payments for any combination of debt instruments from all classes of debt instruments is greater than the remaining principal for the combination of debt instruments by a minimum amount.

The plurality of classes of debt instruments may consist of a first class of debt instruments and a second class of debt instruments.

In a sixth aspect the invention provides a financial product including a plurality of debt instruments from a set of classes of debt instruments having respective maturity payments of each class of debt instrument determined such that the amount of the maturity payment is indeterminable until on or about a maturity date of the debt instruments, such that it is possible for the maturity payment for debt instruments from each class to be less than or equal to any remaining principal for a debt instrument from that class, and such that an aggregate amount of the maturity payments for any combination of debt instruments from a plurality of the classes of debt instruments is greater than the remaining principal for the combination of debt instruments by a minimum amount.

In a seventh aspect the invention provides a system for ordering securities. The system includes an order placement system configured to accept automatically orders for securities from a set of classes of securities having complementary returns such that (a) on their own, their returns are volatile, but (b) the aggregate return of a combination of the securities is less volatile than each of the individual notes or securities.

In an eighth aspect the invention provides a method of distributing debt instruments. The method includes making available a multiple class ordering code representing respective non-zero quantities of debt instruments from a set of classes of debt instruments having respective maturity payments of each class of debt instrument determined such that the amount of the maturity payment is indeterminable until on or about a maturity date of the debt instruments, such that it is possible for the maturity payment for debt instruments from each class to be less than or equal to any remaining principal for a debt instrument from that class, and such that an aggregate amount of the maturity payments for any combination of debt instruments from a plurality of the classes of debt instruments is greater than the remaining principal for the combination of debt instruments by a minimum amount, and making available an order placement system configured to accept automatically orders for debt instruments from the set, wherein the order placement system comprises the multiple class ordering code representing respective non-zero quantities of debt instruments from a plurality of the classes of debt instruments, and the ordering system automatically accepts orders for the debt instruments utilizing the multiple class ordering code.

In a ninth aspect the invention provides a method of distributing debt instruments. The method includes offering debt instruments from a set of classes of debt instruments having respective maturity payments of each class of debt instrument determined such that the amount of the maturity payment is indeterminable until on or about a maturity date of the debt instruments, such that it is possible for the maturity payment for debt instruments from each class to be less than or equal to any remaining principal for a debt instrument from that class, and such that an aggregate amount of the maturity payments for any combination of debt instruments from a plurality of the classes of debt instruments is greater than the remaining principal for the combination of debt instruments by a minimum amount, and making available an order placement system configured to accept automatically orders for offered debt instruments. Other aspects of the invention, including for example further instruments, methods and systems, and combinations of additional features of the various aspects, will be evident from the drawings and detailed description provided herein.

### BRIEF DESCRIPTION OF THE DRAWINGS

For a better understanding of the present invention and to show more clearly how it may be carried into effect, reference will now be made, by way of example, to the accompanying drawings which show the preferred embodiments of the present invention and in which:

FIG. 1 is a graphic illustration of a variable return debt instrument in accordance with an embodiment of an aspect of the invention;

FIG. 2 is a graphic illustration of a set of classes of debt instruments according to FIG. 1 in accordance with an embodiment of an aspect of the invention;

FIG. 3 is a graphic illustration of a financial product based on the set of classes of FIG. 2 in accordance with an embodiment of an aspect of the invention;

FIG. 4 is a graphic illustration of a system for ordering and settling orders for debt instruments of complementary classes in accordance with an embodiment of an aspect of the invention;

FIG. 5 is a graphic illustration of a conversion of orders within the system of FIG. 4 in accordance with an embodiment of an aspect of the invention;

FIG. 6 is a graphic illustration of an alternative two step ordering process utilizing the system of FIG. 5 in accordance with an embodiment of an aspect of the invention;

FIGS. 7-8 are graphic illustrations of example variable rates for example variable return debt instruments of FIG. 1; and

FIG. 9 is a graphic illustration of an example aggregate combined return for an example 1:1 combination of example debt instruments utilizing the variable rates of FIGS. 7 and 8 showing a minimum aggregate return for the combined debt instruments.

### DETAILED DESCRIPTION OF THE PREFERRED EMBODIMENTS

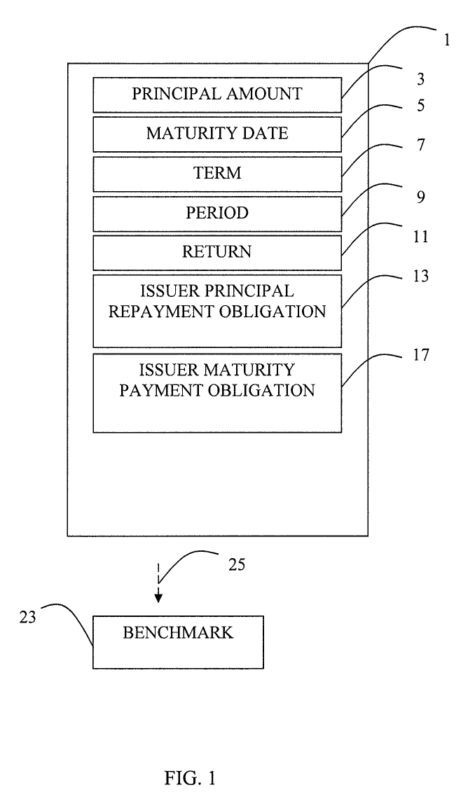

Referring to FIG. 1 a debt instrument 1 has a principal amount (“principal”) 3, a maturity date 5, a term ending on the maturity date 7, a recurring period 9, an obligation for repayment of a portion of the principal during each recurring period of the term 13, and an obligation for payment of a maturity payment at the maturity date 17. The amount of the maturity payment is indeterminable until on or about a maturity date. The amount includes any remaining principal and an amount (the return) determined based on a value of a financial benchmark 23 on or about the maturity date as indicated by arrow 25. Possible amounts for the return include zero or less than zero. Each of the elements of the debt instrument 1 will be contained in terms and conditions which are disclosed in an offering document. Typically the offering document is available in printed form; however, it may also be available as a digital document, such as a document in portable document format (PDF) or another digital document format, or a combination of data from the books and records of an issuer of the debt instrument as permitted by applicable securities legislation. Such books and records may be in a digital format on computer readable media.

Although there may be benefits to investors to accelerate principal repayments as set out above it is not required to do so. It is recognized that entire amounts of principal could be repaid on or about maturity or in accordance with another payment schedule fixed or variable in accordance with a financial benchmark (which may or may not be the financial benchmark 23) or otherwise. In such a case there would not be a recurring period 9 or obligation 13 to repay principal during the term. For ease of reference this description will be made primarily with respect to a debt instrument 1 wherein repayments are made in accordance with a fixed schedule prior to maturity. This is not a limitation of the principles described herein to such an embodiment of debt instruments.

In this example the benchmark 23 is a banker's acceptance rate, such as a 3 month banker's acceptance rate. Another financial benchmark could be used, for example the value of a commodity, equity, fund, index, security, option or other derivative, or other financial investment or combination thereof. In most cases, an issuer will prefer to utilize a financial benchmark 23 that is notionally related to the subject matter of the debt instrument.

The maturity payment 17 may be determined based on a given multiplier of the value of the financial benchmark 23.

The portion 13 of principal to be repaid prior to maturity may be fixed on or before issuance of the instrument. The portion 13 of principal to be repaid in each recurring period prior to the maturity date may be roughly equivalent to interest that would be paid on the principal during such period at prevailing interest rates offered to retail investors on investment grade debt instruments.

In those jurisdictions where returns of principal 3 do not attract tax liability (most, if not all jurisdictions), investors are able to receive periodic payments 13 as in a debt investment, while obtaining tax deferral benefits. The debt instrument 1 provides an alternative investment product with a tax efficient payment stream during the term 7 in those jurisdictions that do not tax principal repayments 13.

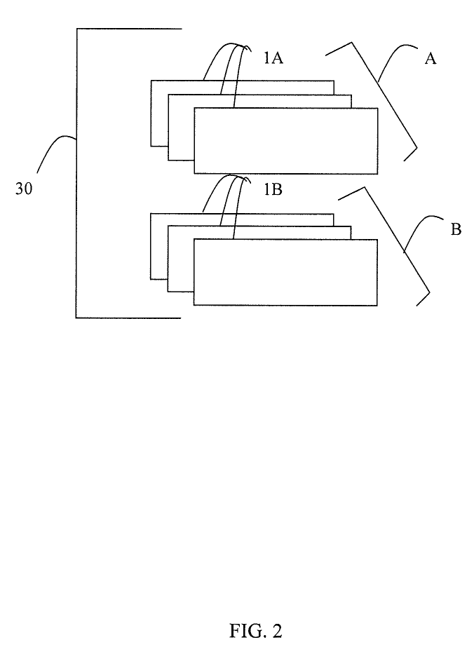

Referring to FIG. 2, a set 30 of classes of debt instruments includes a plurality of classes A, B of debt instruments 1A, 1B in accordance with the debt instruments 1. As represented in FIG. 2, the debt instruments 1A, 1B are debt instruments 1 from class A and class B respectively. In this description the letters A, B will sometimes be used to distinguish between features of debt instruments from class A and class B respectively. In general, classes A, B of debt instruments 1A, 1B are sets of debt instruments 1 wherein each debt instrument 1A or 1B of one class A or B is the same as the debt instruments of other debt instruments in the class A or B, while debt instruments 1A, 1B of different class A, B are different from one another.

The respective amounts of the maturity payments 17 of each class A, B of debt instrument 1A, 1B are determined such that the amount of the maturity payment 17 is indeterminable until on or about a maturity date 5 of the debt instruments 1A, 1B, such that it is possible for the maturity payment 17 for debt instruments 1A, 1B from each class A, B of debt instrument 1A, 1B to be less than or equal to any remaining principal for a debt instrument 1A, 1B from that class A, B, while the aggregate amount of the maturity payments 17A, 17B for any combination of debt instruments 1A, 1B from more than one class A, B of debt instruments 1A, 1B is greater than the remaining principal for the combination of debt instruments 1A, 1B by a minimum amount.

The plurality of classes A, B of debt instruments 1A, 1B may consist of a first class A of debt instruments and a second class B of debt instruments. For simplicity, this description is being made with reference to a set 30 of two classes A, B. It is recognized that there may be more than two classes A, B of debt instruments 1 as desired provided that the debt instruments and any combination of debt instruments from more than one class of debt instruments fulfils the conditions set out above.

Similarly, the FIGS. depict three debt instruments 1A, 1B from each class A, B. This is an example only, less or more debt instruments may form part of each class A, B.

By providing a set 30 of debt instruments 1A, 1B as set out above, a combination of deposit instruments 1A, 1B can provide the tax efficient structure of the individual deposit instruments, while the combination can provide a minimum return greater than zero to the investor. The combination of debt instruments is a set of debt instruments that retain their individual character but have been grouped together for the purposes described herein.

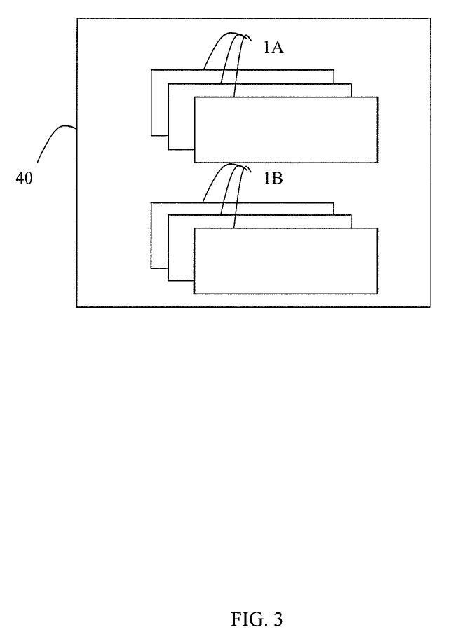

Referring to FIG. 3, a financial product 40 is a combination of a plurality of debt instruments 1A, 1B as set out above.

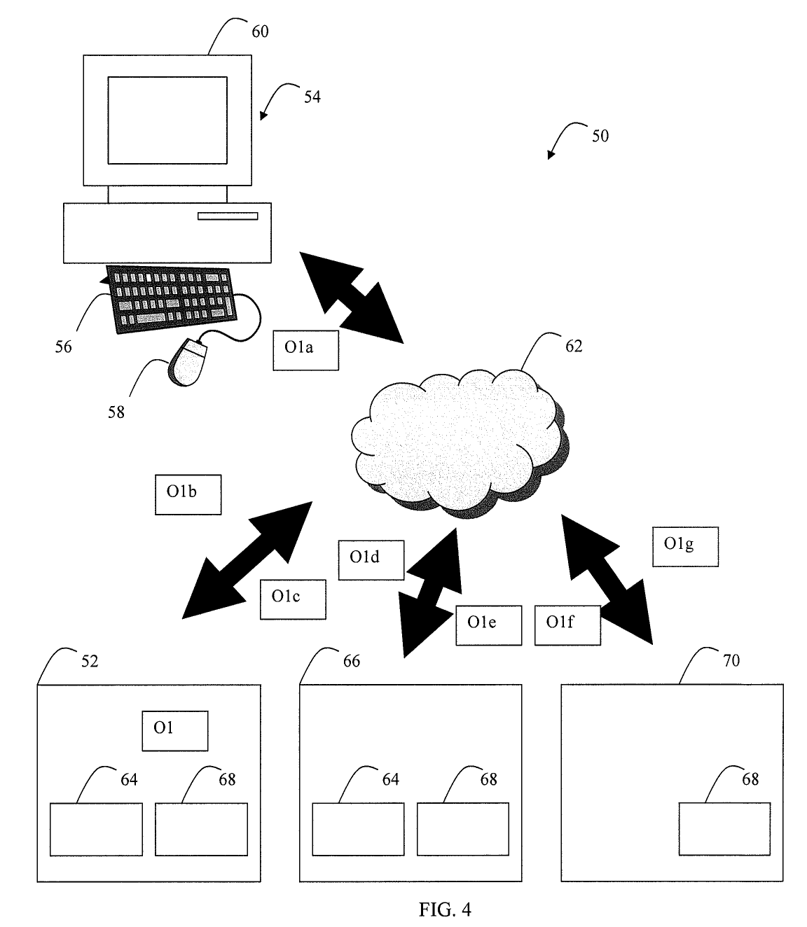

Referring to FIG. 4, a system 50 is provided for ordering debt instruments 1A, 1B. The system 50 includes an order placement system 52 configured to accept automatically orders O1 for debt instruments 1A, 1B described previously. Orders O1 will be described going through a variety of steps using the addition of a reference letter, such as O1a.

The system 50 may further include a computer system 54 having input means, such as keyboard 56 and mouse 58. The computer system 54 communicates orders O1a input through the input means to the order placement system 52 as orders O1b. The computer system 54 may include a graphical display interface 60 to display visually communications between the computer system 54 and the order placement system 52. The computer system 54 may be as personal computer (PC) running a computer program, such as Internet browser software, to communicate through a computer network 62, such as the Internet, with a web server on the order placement system 52.

Many other alternate forms of communicating orders O1 to the order placement system 52, and accepting the orders O1 at the order placement system 52, are possible. For example, the computer system 54 could be part of the order placement system 52 such that orders O1 are entered directly into, and accepted by, the order placement system 52. The computer network 62 could for example be a local area network. The computer system 54 could for example run specialized client software to take some of the processing load from the order placement system.

The order placement system 52 includes a multiple class ordering code 64 representing respective non-zero quantities of debt instruments 1A, 1B from a plurality of the classes A, B of debt instruments, and the ordering system 52 automatically accepts orders O1b for the debt instruments utilizing the multiple class ordering code 64. The order placement system 52 also has single class ordering codes 68 for accepting orders O1 for debt instruments 1A or 1B from single classes A or B. The ordering system 52 has computer hardware and software to perform the features and functions described herein. The ordering system 52 may be a single computer or distributed across many computers with accompanying software.

The system 50 further includes a conversion module 66 configured to convert automatically an order O1 accepted by the order placement system 52 utilizing the multiple class ordering code 64 into respective quantities of each class of debt instruments represented. The order O1 is transmitted as O1c from the order placement system 52 to the conversion module 66 as O1d. The conversion module 66 transmits the converted order as O1e. The converted order O1e may be transmitted to a settlement system 70 as O1f for settling of the order O1 for the debt instruments. Settling will typically require external communication with the registered holder of the debt instrument 1 and possibly with an external settlement agency at O1g.

Alternatively, the order O1e may be returned to the order placement system 52 as an order O1b for the debt instrument from the individual classes. This may be performed through multiple orders O1e, O1b. It may be preferable to use this alternative method as there are existing systems operating to perform order placement which may be configured using existing code addition techniques by adding a multiple class ordering code to the system. The conversion module then looks for orders O1 at the order placement system having the multiple class ordering code 64 and converts those orders O1 to one or more single class ordering code orders O1 on the order placement system 52. The conversion can be performed by replacing the existing multiple class ordering code order with a new single class ordering code order for debt instruments from each class of the multiple class ordering code order. This may be performed by redeeming the original multiple class ordering code order and communicating new single class ordering code orders. The existing order placement systems 52 can then continue to operate as normal to settle the single class ordering code orders using existing communications protocols between the order placement system 52 and the settlement system 70. Some order placement systems 52 and settlement systems 70 are integrated as an order placement and settlement system. Such an integrated order placement and settlement system may be utilized in the system 50 and the methods described herein.

Communication O1g mentioned above may occur on issuance of the notes 1, where typically, a dealer will receive a note 1 from the issuer through a central depository such as the CDS Clearing and Depository Services Inc. (CDS) 403. Like most publicly traded securities in Canada, trades in notes 1 may be settled electronically through computer facilities maintained and administered by CDS, using its book-based debt clearance settlement system or DCS. After issuance of the classes A, B of notes 1 by the issuer, global certificates representing notes 1 in the respective classes A, B will typically be deposited with the central depository, a nominee of which is recorded on the books of the issuer as the sole registered holder of the certificates. Subsidiary interests in blocks of notes 1 from the global certificate, representing a beneficial interest in the notes 1, will be transferred to the dealer that wishes to sell notes 1. The dealer then transfers the rights in the notes to the investor. The central depository is typically registered by the issuer in a register of the issuer as the owner of the notes 1 under the global certificate, and the dealer is registered in a register of the depository as the owner of an interest in its block of notes 1. The investor is recorded as the beneficial owner of notes 1 in a client account held with the dealer. Neither the dealer nor the investor will hold a physical certificate evidencing its interest in the notes 1. The legislative framework that gives legal effect to electronic transfers of interests in the physical global certificate lodged with the depository is provided federally by the Depository Bills and Notes Act and provincially (in Ontario) by the Securities Transfer Act 2006.

Subsidiary interests in other blocks of notes 1 may be issued to another dealer for transfer to yet another dealer and subsequent transfer to another investor. Each of the dealers will maintain its own account records respectively showing the entity that each dealer considers to be the beneficial owner of notes 1.

The entitlement with respect to any particular note 1 is determined by examining the registers, computer ledgers and account records of the depository and various intermediaries. The distributed records of the dealers and of the central depository are typically maintained as entries in distributed computer databases maintained respectively by or for the dealers and the central depository, and connected, directly or indirectly, for communication purposes, through computer programs and a proprietary communications network that permits participants in the depository such as dealers and financial institutions to initiate and track trades directly from remote input devices, as is known in the industry.

It is to be recognized that there is no legal requirement for a physical certificate evidencing a note 1, such as a “definitive” or even a global printed promissory note. The note 1 may exist only as a series of book-based entries. Canadian provincial government investment securities are typically now issued only in this “book-entry only” form. However, current market practice and applicable legislation dictate that most if not all non-government note issues are evidenced by at least global certificates which are deposited with a depository, and typically the investor is not entitled to receive a “definitive” certificate except in the unlikely event that the depository ceases to operate.

The issuer may also appoint a paying and transfer agent to receive information from the participants regarding transfers of ownership and the then current owner of note 1. Such information may be stored in a computer database 443 maintained by or for the paying and transfer agent.

The order placement system 52 may be configured to accept automatically orders O1 for the debt instruments utilizing a set of class ordering codes 64 and 68 representing a series of combinations of quantities of debt instruments from one or more classes of debt instruments. The series may be a plurality of single and multiple, or exclusively multiple, class ordering codes representing an ordered progression of possible combinations of quantities of debt instrument from different classes. As an example, there may be two single class ordering codes for debt instruments from respective classes A, B and a multiple class ordering code for an equal quantity of debt instruments from each of class A and class B. The conversion module is similarly configured to convert orders accepted utilizing the set of class ordering codes into orders for respective quantities of each class of debt instruments.

The conversion module 66 may be separate from the order placement system 52 and interact automatically with the order placement system 52 as shown in the FIGS. Alternatively, the conversion module 66 may be part of the order placement system 52, the settlement system 70 or a combined order placement and settlement system.

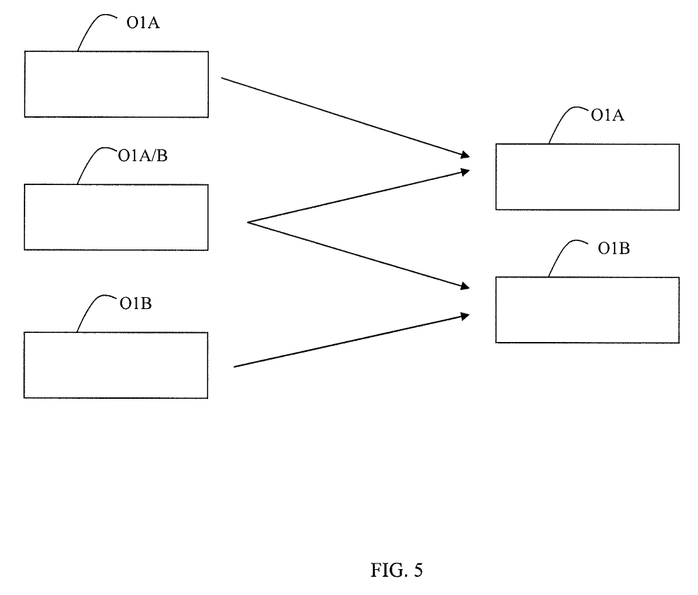

Referring to FIG. 5, an alternative view of conversion from a multiple class ordering code order O1A/B to a single class ordering code orders O1A, O1B are shown in the center process. The FIGS. also show the elements of a two step process from initial orders O1A, O1A/B, O1B (to the left of the FIG.) including orders with multiple class ordering code orders to single class ordering code orders O1A, O1B to the right of the FIG. A detailed example of the two step process is discussed when discussing a FundSERV system implementation below.

In operation, orders O1 are accepted for debt instruments from a set of classes of debt instruments having respective maturity payments of each class of debt instrument determined such that the amount of the maturity payment is indeterminable until on or about a maturity date of the debt instruments, such that it is possible for the maturity payment for debt instruments from each class to be less than or equal to any remaining principal for a debt instrument from that class, and such that an aggregate amount of the maturity payments for any combination of debt instruments from a plurality of the classes of debt instruments is greater than or equal to the remaining principal for the combination of debt instruments.

Orders O1 are accepted utilizing a multiple class ordering code 64 representing respective non-zero quantities of debt instruments 1A, 1B from a plurality of the classes A, B of debt instruments. Orders O1 are accepted utilizing a set of greater than two class ordering codes 64, 68 representing a series of combinations of quantities of debt instruments 1A, 1B from a plurality of the classes A, B of debt instruments. The ordering code 64, 68 may be made available in the offering document to permit orders to be communicated to the order placement system 52, for example through computer system 54. The codes 64, 68 may be made available by the order placement system 54, for example through the display 60 of computer system 54. Many other methods and devices may be used to make available, directly or indirectly, the codes for use in ordering.

Orders O1 accepted during the step of accepting orders are automatically accepted at order placement system 52 which is configured to accept automatically the orders O1. The step of accepting orders O1 can include accepting orders utilizing a multiple class ordering code 64 representing respective quantities of debt instruments from a plurality of the classes of debt instruments.

Accepting orders can include accepting orders O1 utilizing a set of class ordering codes 64, 68 representing a series of combinations of quantities of debt instruments 1A, 1B from a plurality of the classes A, B of debt instruments. Orders O1 may be input through a computer system 54 for communication to the order placement system 52.

Communications between the computer system 54 and the order placement system 52 may be visually displayed on a display 60 of the computer system 54.

A quantity of debt instruments 1A, 1B in orders O1 accepted by the order placement system 52 utilizing a multiple class ordering code 64 are automatically converted into orders O1 to the order placement system 52 for respective quantities of each class A, B of debt instruments represented utilizing respective single class ordering codes 70.

A further detailed example of the debt instrument 1, as a deposit note 1, and systems and methods for ordering the debt instrument 1 will now be described. The reference numerals for many of the elements described above will be reused for this detailed example for reference to detailed example implementations of the elements described above. This is being done for ease of reference and is a limitation of the previously described elements to the specific example embodiment to be described.

A deposit note 1 is a note issued by a deposit taking institution that is responsible for the obligation under the note. A deposit note may confer other benefits, such as eligibility for investment in tax deferred retirement savings plans such as the registered retirement savings plans provided for under Canadian tax legislation.

A deposit is a liability of a deposit taking institution that is usually payable to the depositor upon demand without prior notice. Although not often regarded as a loan, a deposit is legally a debt obligation of the deposit taking institution to the depositor that by statute usually has priority in right of payment to other obligations of the deposit-taking institution on insolvency. In many jurisdictions it is illegal for non-deposit taking financial institutions to take a deposit. In many jurisdictions deposit taking financial institutions are required to have insurance for deposits, such as FDIC insurance in the United States or CDIC insurance in Canada or similar mandatory deposit insurance in other jurisdictions. A deposit account records the amount of deposits for which the deposit taking institution is liable, to the account holder. A deposit account may have various features such as the payment of interest on deposits or the right to make loans by way of overdraft or a line of credit in addition to making or withdrawing deposits.

A deposit note 1 can provide significant benefits over notes issued by an entity other than a deposit taking institution. For example, most likely the transaction costs will be higher for a non-deposit note (which may be a debt instrument 1, but would not be deposit note 1) from an issuer that is not a deposit taking institution as a more rigorous mandatory disclosure document (offering document) such as a prospectus and additional regulatory approvals may be required. It may also take more time to issue as a result. As an example, in Canada the offering document typically provided for a deposit note is an information statement, which is not mandated by law, whereas the offering document required for issuance of a non-deposit note by an entity other than a deposit taking institution, that cannot otherwise avail itself of an appropriate exemption, is a prospectus. Typically a deposit taking institution is a low credit risk. This further enhances the value of the obligations to an investor.

Where a deposit note 1 is issued under an exemption from the prospectus and registration requirements of securities law, using a disclosure document such as an information statement, the deposit note 1 cannot be transferred except under certain restrictions. In order to allow for transfer of a deposit note 1, a deposit taking institution may provide a secondary market by purchasing issued deposit notes 1 and reissuing them under an applicable securities law exemption.

An individual deposit note 1 issued by a deposit taking institution provides for (a) periodic repayments of principal prior to the maturity date of the instrument, (b) payment of the deposit balance at maturity, and (c) payment at maturity of a return, the quantum of which is determined by a formula that references a financial benchmark 23 of a future interest rate (the “Reference Rate”) and one or more fixed interest rates. The Reference Rate in the instruments is the “3-Month BA Rate” on a day (the “Valuation Date”) that is three business days prior to the maturity date of the instrument, being the average rate for three-month Canadian dollar bankers' acceptances that appears on the Reuters Screen CDOR Page as of 10:00 a.m., Toronto time on such date; provided that if such rate does not appear on the Reuters Screen CDOR Page on the Valuation Date, the rate will be determined on the basis of the arithmetic mean (rounded to the nearest one-thousandth of one percent, with 0.0005 being rounded up) of the bid rates per annum of five major Canadian banks identified in the offering documents for the instrument for three-month Canadian dollar bankers' acceptances for settlement on the Valuation Date and in an amount of $10,000,000 in Canadian currency accepted by such banks as of 10:00 a.m., Toronto time. For this purpose, a calculation agent referred to in the offering documents for the instrument will request a principal Toronto office of each such bank to provide a quotation of its rate. If any of such banks have not provided quotes then the bids of only those banks that provided bid quotations shall be used for purposes of determining the 3-Month BA Rate.

Two particular classes A, B of debt instruments 1A, 1B have been created. The return payable at maturity (“Variable Return”) on each such instrument is determined by the formula:

Variable Return=Deposit Balance at Maturity×Variable Rate.

For this purpose, Deposit Balance at Maturity for each debt instrument is an amount equal to the difference between the initial principal amount of $100 per debt instrument and the principal repaid on the debt instrument prior to maturity.

The Variable Rate on one class A of debt instrument 1A (the “Bull Note”), is determined by the following formula (the “Bull Rate Formula”):

Variable Rate=max[0,(RR−BullRate1)]×Multiplier.

Thus the Variable Rate on such instrument is equal to the product of (1) the greater of (a) zero, and (b) the Reference Rate less BullRate1, and (2) the Multiplier. For purposes of this instrument, BullRate1 and the Multiplier can be unknown prior to, and fixed on, the closing date of the offering of the Bull Note.

The Variable Rate on the other class B of debt instrument 1B (the “Bear Note”), is determined by the following formula (the “Bear Rate Formula”):

Variable Rate=max[0,(BearRate1−RR)]×Multiplier+max[0,(RR−BearRate2)]×Multiplier

Thus the Variable Rate on such instrument is equal to the sum of (A) the product of (1) the greater of zero and the difference between BearRate1 and the Reference Rate, and (2) the Multiplier, plus (B) the product of (3) the greater of zero and the difference between the Reference Rate and BearRate2 and (4) the Multiplier. For this purpose, BearRate1, BearRate2 and the Multiplier for such instrument can be unknown prior to, and fixed on, the closing date of the offering of such debt instrument.

The two notes 1A, 1B provide distinctive returns at maturity of the notes, based on the Reference Rate on the Valuation Date of the notes. The Bull Note provides no return if the Reference Rate is less than or equal to BullRate1, and pays a progressively increasing return as the Reference Rate increases above BullRate1. The Bear Note provides no return if the Reference Rate is equal to or greater than BearRate1 but less than or equal to BearRate2. If the Reference Rate is less than BearRate1, the Variable Return increases progressively as the Reference Rate approaches 0%. If the Reference Rate exceeds BearRate2, the Variable Return increases progressively as the Reference Rate increases.

The two classes A, B of notes 1A, 1B are complementary in that the return on each class of note, on its own, is indeterminable prior to maturity and it is possible that no return will be payable on a particular note. However, if an investor owns notes 1A, 1B from both classes A, B, the investor is certain to receive a minimum aggregate return greater than zero from holding both notes, depending on where the variables in the Bull Rate Formula and the Bear Rate Formula are fixed. Investors that have a particular view on future interest rates (as reflected in the Reference Rate) may take positions that may provide favourable returns by investing in the notes. An investor who believes that future interest rates will be high may wish to acquire the Bull Rate notes 1A, because the return payable on a Bull Note 1A is higher as the Reference Rate 23 is higher. Conversely, an investor who believes that future interest rates will be low may wish to acquire the Bear Rate notes 1B, because the return payable on a Bear Rate note is relatively high when the Reference Rate 23 is low. Investors can purchase a combination of notes 1A, 1B in any combination to provide the potential return profile that reflects their view of future interest rates.

The notes 1A, 1B are offered to investors individually and in a 1:1 combination under an Information Statement.

Purchases of the notes 1A, 1B can be effected using the FundSERV™ electronic order placement and settlement system, as an integrated order placement system 52 and settlement system 70, provided by FundSERV Inc. of Toronto, Canada. Separate FundSERV codes 64, 68 have been established for each of the Bull Note 1A, the Bear Note 1B and a 1:1 combination of Bull Note 1A and Bear Note 1B.

The FundSERV system is an electronic ordering and settlement system through which participants can effect transactions for financial instruments. Using FundSERV, an order for a security is placed using a code established for that security. As an additional step, if interest on money advanced in respect of the period prior to closing of an offering of a security is to be earned by investors, the security will be ordered using a cash code. On the closing of the offering, the cash and interest represented by the cash code will be automatically applied to purchase the appropriate principal amount of the desired security. This is effected by an automatic redemption order placed in respect of the cash code, and an automatic purchase order placed in respect of the security. The redemption order would be effected using the applicable cash code. The purchase order would be effected using a separate code that is established for the security. If an investor wants to sell the security in the future, the sale would be effected by placing a redemption order using the code established for the security.

The FundSERV system facilitates the placement, reconciliation and net settlement of orders for financial instruments. FundSERV provides a payment exchange facility (through third parties) and a net settlement messaging service that facilitates the exchange of customer net settlement payment messages (i.e. confirmation of wire transfers).

To purchase a Bull Note 1A, a Bear Note 1B or the 1:1 combination of Bull Note 1A and Bear Note 1B, an investor will request that his or her investment advisor or intermediary (the “IA”) place an order for the notes 1A, 1B desired. The IA will place the order online, typically through his or her computer system 54, using the FundSERV code or codes 64, 68 that correspond with the notes 1A, 1B or combination of notes that the investor desires to purchase. Once the order has been completed an d notes have been issued in respect of the order, the FundSERV system will notify the IA that the investor's order has been filled. The IA will, in turn, notify the investor that his or her order has been filled and the investor's investment statements with the IA will reflect beneficial ownership of the notes purchased.

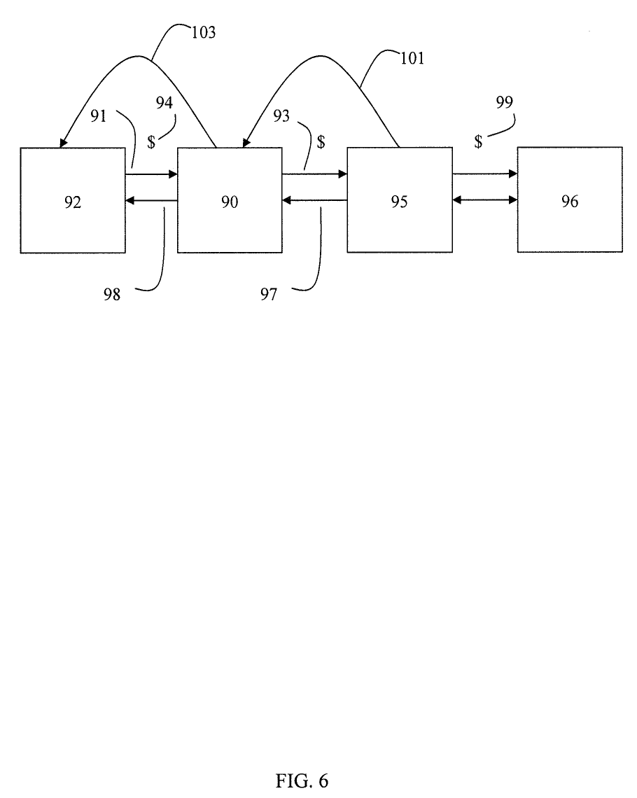

Referring to FIG. 6, the codes 464, 68 can be part of a set of codes utilized in a two step process having additional ordering codes to separate initial ordering using single class ordering codes 86 and ordering single classes of debt instruments at closing. Considering again using a FundSERV system 90 as an example, an issuer establishes a separate FundSERV code on the FundSERV system 90 (each, a “Specified Cash Code”) for a plurality of combinations of debt instruments to be offered for order. Using the example described herein there are three specified cash codes (ordering codes 64, 68), one for each class and one for a 1:1 combination. The Specified Cash Codes can be set to be operative only prior to the closing of the offering of the notes 1A, 1B and can be used to facilitate the temporary placement of investor funds in interest bearing accounts.

In addition to the Specified Cash Codes, two additional FundSERV Codes (the “Sweep Codes”) can be used to facilitate the purchases of the two classes of notes 1A, 1B (i.e., each class A, B of note will have its own separate Sweep Code). On the closing of the offerings of notes 1A, 1B, funds held in an interest bearing account represented by a Specified Cash Code will be used to purchase notes 1A, 1B in the proportion designated by the applicable Specified Cash Code. The following process will occur when an investor subscribes for notes 1A, 1B:

(a) The investor's investment advisor will place a purchase order 91 through his or her computer system 92 to the FundSERV system 90 using the applicable Specified Cash Code.
(b) On the settlement 94 of the purchase order, the investor's money 93 will be placed in an interest bearing account by the issuer's broker/dealer computer system 95, and the order will be acknowledged 97 to FundSERV system 90 which will acknowledge 98 the order to the investor's broker dealer computer system 92.
(c) On the closing of the offering of notes 1A, 1B as indicated 101 by the issuer's broker/dealer system 95, the investor's funds 99 will be applied to the issuer through an issuer computer system 96 to purchase notes 1A, 1B in the proportions represented by the applicable Specified Cash Code. This will be effected by an automatic FundSERV redemption order (using the Specified Code), followed by automatic purchase orders using the Sweep Codes, to effect the purchase of notes 1A, 1B in the particular proportions stipulated by the applicable Specified Cash Code. The FundSERV system 90 will communicate 103 accordingly with the investor's broker/dealer computer system 92.
(d) By virtue of ordering under the mechanism described above, the investor's broker/dealer system 92 will record that the appropriate number of notes 1A, 1B have been allocated to it. The books and records in the broker/dealer computer system 103 will reflect beneficial ownership of the notes 1A, 1B by the investor.

Once used for purposes of ordering notes 1A, 1B, the Specified Cash Codes can cease to be operative in respect of the offering of notes 1A, 1B. However, the Sweep Codes can remain operative, and future redemptions of notes 1A, 1B can be effected by placing redemption orders using the applicable Sweep Codes.

Once a Specified Cash Code is no longer operative, it can be recycled for other purposes.

The systems and methods described for the use in ordering the notes 1A, 1B can also be used for other sets of complementary notes, or other complementary securities. It is understood that debt instruments are one form of security. Equities are another form of securities. The system and methods described herein can be adapted to any set of securities having complementary returns such that (a) on their own, their returns are uncertain and/or volatile, but (b) the aggregate return of a combination of the securities is less volatile than each of the individual notes or securities. Accordingly, sets of notes or securities having complementary features can be created and offered to investors in pre-established combinations. Again, as an example, the FundSERV system can be used to allow convenient ordering, for example by investment advisors, of the pre-established combinations of securities offered.

An example principal repayment schedule during the term for deposit notes 1A, 1B described above and set to mature on or about 07/01/2012 (Jul. 1, 2012) is set out below in Table 1.

TABLE 1

| Deposit Repayment | Deposit Repayment |
|---|---|
| Date | Amount |
| Jan. 01, 2008 | $2.00 per Deposit Note |
| Jul. 01, 2008 | $2.00 per Deposit Note |
| Jan. 01, 2009 | $2.00 per Deposit Note |
| Jul. 01, 2009 | $2.00 per Deposit Note |
| Jan. 01, 2010 | $2.00 per Deposit Note |
| Jul. 01, 2010 | $2.00 per Deposit Note |
| Jan. 01, 2011 | $2.00 per Deposit Note |
| Jul. 01, 2011 | $2.00 per Deposit Note |
| Jan. 01, 2012 | $2.00 per Deposit Note |

Example parameters for Bull Notes 1A described above are set out in Table 2 below.

TABLE 2

| | |
|---|---|
| Deposit Balance at Maturity | $82.00 |
| Reference Rate (or RR) | 3-Month BA Rate on the Valuation |
| | Date (3 Business days prior to |
| | maturity) |
| Rate1 | 1.00% |
| Multiplier | 6.9 |

Example parameters for Bear Notes 1B described above are set out in Table 2 below.

TABLE 3

| | |
|---|---|
| Deposit Balance at Maturity | $82.00 |
| Reference Rate (or RR) | 3-Month BA Rate on the Valuation |
| | Date (3 Business days prior to |
| | maturity) |
| Rate1 | 8.75%* |
| Rate2 | 9.25%* |
| Multiplier | 6.90 |

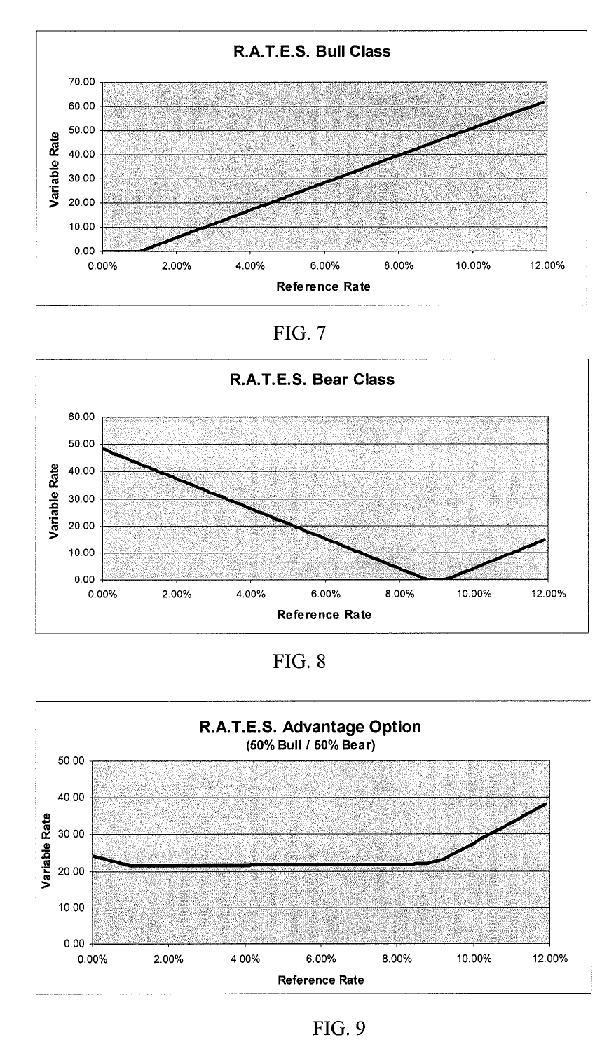

Referring to FIGS. 7-9, example variable rates are provided for different reference rates for the Bull Notes 1A and Bear Notes 1B and a 1:1 combination of classes of debt instruments based on the parameters and formulae set out in the Tables above.

It will be understood by those skilled in the art that this description is made with reference to the preferred embodiment and that it is possible to make other embodiments employing the principles of the invention which fall within its spirit and scope as defined by the following claims.

I claim:

1. A system for ordering debt instruments, the system comprising: an order placement system configured to accept automatically orders for debt instruments from a set of classes of debt instruments having respective maturity payments of each class of debt instrument determined such that the amount of the maturity payment is indeterminable until on or about a maturity date of the debt instruments, such that it is possible for the maturity payment for debt instruments from each class to be less than or equal to any remaining principal for a debt instrument from that class, and such that an aggregate amount of the maturity payments for any combination of debt instruments from a plurality of the classes of debt instruments is greater than the remaining principal for the combination of debt instruments by a minimum amount.

2. The system of claim 1 wherein the order placement system comprises a multiple class ordering code representing respective non-zero quantities of debt instruments from a plurality of the classes of debt instruments, and the ordering system automatically accepts orders for the debt instruments utilizing the multiple class ordering code.

3. The system of claim 2 further comprising: a conversion module configured to convert automatically an order accepted utilizing the multiple class ordering code into respective quantities of each class of debt instruments represented.

4. The system of claim 2 further comprising: a conversion module for converting automatically an order accepted utilizing the multiple class ordering code into orders to the order placement system for respective quantities of each class of debt instruments represented, wherein the order placement system is configured to accept orders for each class of debt instruments utilizing respective single class ordering codes.

5. The system of claim 1 wherein the order placement system is configured to accept automatically orders for the debt instruments utilizing a set of class ordering codes representing a series of combinations of quantities of debt instruments from one or more classes of debt instruments.

6. The system of claim 5 further comprising: a conversion module for converting orders accepted utilizing the set of class ordering codes representing a series of combinations of quantities of debt instruments from a plurality of the classes of debt instruments into orders for respective quantities of each class of debt instruments.

7. A method of ordering debt instruments, the method comprising the steps of: accepting orders for debt instruments from a set of classes of debt instruments having respective maturity payments of each class of debt instrument determined such that the amount of the maturity payment is indeterminable until on or about a maturity date of the debt instruments, such that it is possible for the maturity payment for debt instruments from each class to be less than or equal to any remaining principal for a debt instrument from that class, and such that an aggregate amount of the maturity payments for any combination of debt instruments from a plurality of the classes of debt instruments is greater than or equal to the remaining principal for the combination of debt instruments.

8. The method of claim 7 wherein orders are accepted utilizing a multiple class ordering code representing respective non-zero quantities of debt instruments from a plurality of the classes of debt instruments.

9. The method of claim 7 wherein orders are accepted utilizing a set of greater than two class ordering codes representing a series of combinations of quantities of debt instruments from a plurality of the classes of debt instruments.

10. The method of claim 7 wherein orders accepted during the step of accepting orders are automatically accepted at an order placement system configured to accept automatically the orders.

11. The method of claim 7 wherein the step of accepting orders further comprises: accepting orders utilizing a multiple class ordering code representing respective quantities of debt instruments from a plurality of the classes of debt instruments.

12. The method of claim 7 wherein the step of accepting orders further comprises: accepting orders utilizing a set of class ordering codes representing a series of combinations of quantities of debt instruments from a plurality of the classes of debt instruments.

13. The method of claim 7 further comprising the step of inputting orders through a computer system for communication to the order placement system.

14. The method of claim 7 further comprising the step of: automatically converting a quantity of debt instruments in orders accepted by the order placement system utilizing a multiple class ordering code into respective quantities of each class of debt instruments represented.

15. The method of claim 7 further comprising the step of: automatically converting a quantity of debt instruments in orders accepted by the order placement system utilizing a multiple class ordering code into orders to the order placement system for respective quantities of each class of debt instruments represented utilizing respective single class ordering codes.

16. The method of claim 7 further comprising the step of: prior to accepting orders, configuring the order placement system to accept the orders.

17. A debt instrument comprising:
a) a principal amount (“principal”),
b) a maturity date,
c) a term ending on the maturity date,
d) an obligation for repayment of the principal by on or about the maturity date, and
e) an obligation for payment of a maturity payment at the maturity date,
wherein, the amount of the maturity payment is indeterminable until on or about the maturity date, and is determined based on a value of a financial benchmark on or about the maturity date.

18. The debt instrument of claim 17 wherein the maturity payment is determined based on a given multiplier of the value of the financial benchmark.

19. The debt instrument of claim 17 further comprising a recurring period and wherein a portion of principal is to be repaid during each recurring period of the term.

20. A set of classes of debt instruments comprising:
a plurality of classes of debt instruments in accordance with claim 17,
wherein the respective amounts of the maturity payments of each class of debt instrument are determined such that the amount of the maturity payment is indeterminable until on or about a maturity date of the debt instruments, such that it is possible for the maturity payment for debt instruments from each class of debt instrument to be less than or equal to any remaining principal for a debt instrument from that class, and such that the aggregate amount of the maturity payments for any combination of debt instruments from all classes of debt instruments is greater than the remaining principal for the combination of debt instruments by a minimum amount.

21. The set of classes of debt instruments of claim 20, wherein the plurality of classes of debt instruments consists of a first class of debt instruments and a second class of debt instruments.
